(19) United States
(12) Patent Application Publication
(10) Pub. No.: US 2022/0357113 A1
(43) Pub. Date: Nov. 10, 2022

(54) HEAT TRANSFER EQUIPMENT

(71) Applicant: Devang JHAVERI, MumbaI (IN)

(72) Inventor: Devang JHAVERI, MumbaI (IN)

(21) Appl. No.: 17/871,899

(22) Filed: Jul. 23, 2022

Related U.S. Application Data
(63) Continuation of application No. PCT/IN2021/050428, filed on May 3, 2021.

(30) Foreign Application Priority Data
Oct. 27, 2020 (IN) 202021046876

(51) Int. Cl. F28F 1/36; B23K 26/08; B23K 26/302; B23P 15/26

(52) U.S. Cl. CPC F28F 1/36; B23K 26/0823; B23K 26/302; B23P 15/26; F28F 2275/067; B23K 2101/14

(57) ABSTRACT

The present invention provides a heat transfer equipment at rapid rate of thermal diffusion across the temperature gradient. The present invention further provides a method of manufacturing of a heat transfer equipment. The various embodiments of the present invention provide various methods for manufacturing of heat transfer equipment by affixing the loop or a solid member (201) containing crests and troughs on the surface of the central hollow member (101) by use of laser weld (301). The invention would provide much higher strength to the equipment and have much higher temperature sensitivity.

### CROSS-REFERENCE TO RELATED APPLICATIONS

This Application is a CONTINUATION application claiming the benefit of priority of the co-pending International Patent Application No. PCT/IN2021/050428 with an international filing date 03 May 2021 that designated the United States, which claims the benefit of priority of the Republic of INDIA Application No. 202021046876, filed 27 Oct. 2020, the entire disclosures of each (and all) of which Applications are expressly incorporated by reference in their entirety herein.

### TECHNICAL FIELD

The present invention relates to a heat transfer equipment. The present invention more particularly refers to a method of manufacturing a heat transfer equipment by welding the loops onto a central hollow cylindrical member.

### BACKGROUND OF INVENTION

Heat transfer equipment in fluids and fluid like member have gained a lot of modifications over the years. Conventionally a single cylindrical metal heat transfer equipment was used to transmit heat across the surface of the cylindrical metal to the fluid/member having fluid properties. However, the conventional system of having a single tube gradually started becoming inconvenient and there was a need for an equipment that could diffuse heat across the temperature gradient in shorter period of time and the older equipment was becoming obsolete. Need for a faster equipment gave a rise to an equipment with cylindrical members of metal or other heat conducting member came to be used with discs wrapped around rapid rate of transmission of heat thereby reducing the time to a great extent. One of the inventions which describes a similar equipment to the one mentioned in prior art is CN206095021U. The said prior art teaches about laser welding of fin plate on the cylindrical tube in a helical manner. However, the equipment prepared by teachings of the aforementioned prior art has certain drawbacks such as high time consumption for manufacturing and less than required rate of thermal transmission. There is a need for an equipment to increase the rate of thermal transmission across the temperature gradient. The following invention describes a method for preparation of an equipment for increased rate of temperature across the temperature gradient between one or more fluids or member having fluidic properties. The above-mentioned shortcomings, disadvantages and problems are addressed herein, as detailed below.

### OBJECTIVES OF THE INVENTION

The primary objective of the present invention is to provide an equipment for higher rate of thermal transmission across the temperature gradient in fluids and member having fluid properties.

Another object of the present invention is to manufacture an equipment with higher surface area for rapid thermal transmission.

Yet another object of the present invention is to provide an equipment with loops welded to the cylindrical hollow member for rapid thermal transmission across the temperature gradient.

Yet another object of the present invention is to prepare the equipment using laser welding.

These & other objects & the advantages of the embodiments will become readily apparent from the following detailed description taken in conjunction with the accompanying drawings.

### SUMMARY OF THE INVENTION

Various embodiments of the present invention provides us a heat transfer equipment. The embodiments herein also provide a method of manufacturing the heat transfer equipment for rapid rate of thermal transmission.

In an embodiment, an equipment for rapid rate of thermal transmission is provided. The equipment comprises of a hollow member of pre-defined thickness having cylindrical, triangular, square, pentagonal, hexagonal or any such shape made of metal or any other member possessing good thermal conducting properties.

In another embodiment, the equipment also contains a series of a solid member having pre-defined diameter cylindrical/triangular/square/pentagonal/hexagonal or any such shape made of metal or any other heat conducting member arranged in crests and troughs manner.

In yet another embodiment of the present invention, the series of crests and troughs are affixed on the hollow member by laser welding.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 illustrates the central hollow member (101)

FIG. 2 illustrates the solid member (201) in spiral form having crests and troughs.

FIG. 3 illustrates attachment of solid member on hollow member when the hollow member is rotating in anti-clockwise direction.

FIG. 4 illustrates laser welding by impact of laser (301) on the troughs before bringing the troughs in contact with the central member.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Various embodiments of the present invention provides us a heat transfer equipment. The embodiments herein also provide a method of manufacturing the heat transfer equipment for rapid rate of thermal transmission.

The terms “cylinder”, “hollow cylinder”, “cylindrical member”, “central member”, “central hollow member” may be used interchangeably in the following detailed description. The words “equipment” and “apparatus” may also be used interchangeably in the following detailed description. The words “solid member”, “solid member of crests and troughs” and “loops” may also be used interchangeably in the following detailed description. The words “welding” and “laser welding” may also be used interchangeably in the following detailed description.

The following equipment is designed for various applications in various kinds of industries requiring heating or cooling of the fluid or a member possessing fluid properties that is passed through the central hollow member.

The equipment is designed and produced such that the solid member is moulded into loops or members having crests and troughs of pre-determined height, radius and length between to consecutive crests or troughs. The loops or solid members of crests and troughs are affixed onto the outer surface of the hollow member by means of welding. The presence or attachment of loops or solid member of crests and troughs facilitates rapid rate of thermal diffusion across the temperature gradient in the fluid or fluidic member.

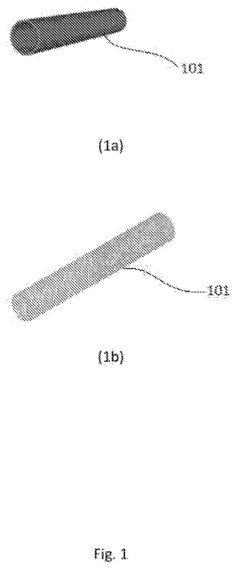

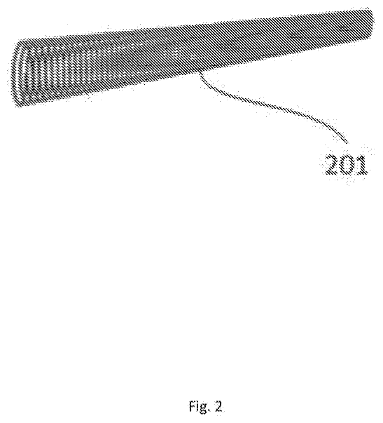

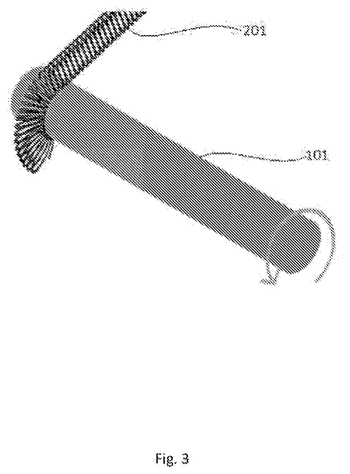

In one embodiment of the present invention, a metal or member having good thermal conductivity and good malleability which is hollow from the centre is used as a central member. The said hollow cylinder need not necessarily be of cylindrical shape. The essential aspect is that it should be hollow from within having two sides. FIG. 1 shows the hollow member (101). With respect to the hollow member as seen in FIG. 1, the said hollow member can be of varied length and thickness with inner and outer radius being specific to the requirement of equipment. A solid member (201) having good malleability and good thermal conduction properties is taken and moulded into continuous loop of crests and troughs of a pre-determined height and distance between consecutive crests or troughs. FIG. 2 shows the solid member (201) in the form of crests and troughs. The hollow member has radius greater than the radius of the solid member. The said solid member (201) is then held above the central member (101) at right angle or tangential to the central member and is brought down to affix the solid member (201) on the central hollow member (101). The laser beam (301) is projected on the central member at the point of contact of the troughs to the central member when the solid member (201) is approximately 1-5 mm away from the central member (101). FIG. 3 illustrates attachment of solid member on hollow member when the hollow member is rotating in anti-clockwise direction. The rotation of central hollow member (101) can be either in clockwise or anti-clockwise direction.

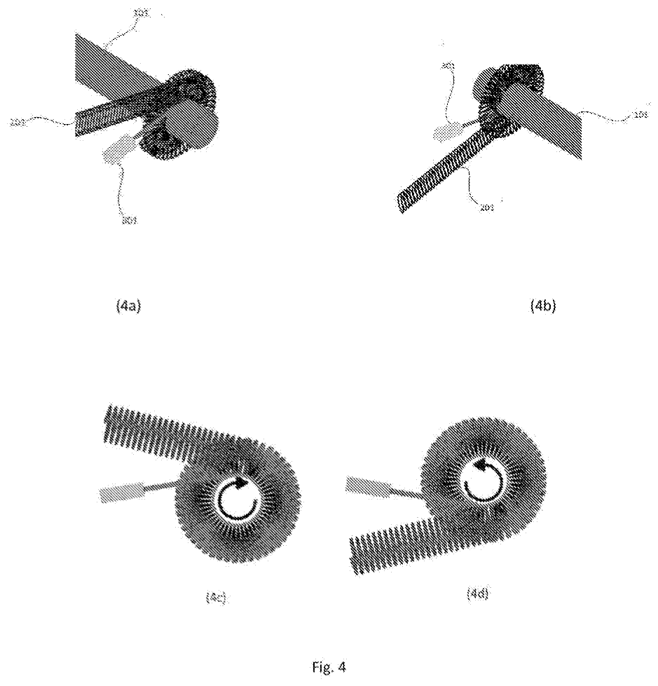

In another embodiment of the present invention, the laser beam (301) is projected on the troughs when they are about 1-5 mm away from contact with the central member (101). The laser beam (301) causes the troughs to melt and immediate contact with the central member (101) causes the material of solid member (201) to fuse with the central hollow member (101). FIG. 4 illustrates the laser welding on central surface at the points of contacts of troughs to the central member (101). The accurate and concentrated projection of laser beam (301) at the points of contacts of the troughs causes narrow and deep welds on the central member (101) and the solid member (201) is brought into contact with the central member (101) causing the solid member (201) to be affixed on the central member (101).

In yet another embodiment of the present invention, the laser beam (301) is projected continuously along the circumference of the central member (101) when the solid member (201) is about 1-5 mm away from contact and the solid member (201) is immediately brought into contact with the central hollow member (101) to form weld.

In yet another embodiment of the present invention, the solid member (201) is held below the central hollow member (101) and the methods illustrated in either [0023], [0024] or [0025] is followed to form weld between the solid member (201) and central hollow member (101). FIGS. 4(b) and 4(d) illustrates position of the solid member (201) below the central hollow member (101).

Once few troughs have been welded with the central hollow member with help of laser weld, the central member (101) is then rotated on clockwise or anti-clockwise direction for the entire solid member (201) to be affixed on the central hollow member by laser fusion.

Although the embodiments herein are described with various specific embodiments, it will be obvious for a person skilled in the art to practice the invention with modifications. However, all such modifications are deemed to be within the scope of the claims.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the claims.

### ADVANTAGES OF THE INVENTION

The present invention discloses various embodiments of heat transfer equipment. The said method causes the manufacturing to be cost-effective and less thermosensitive as the product obtained by laser welding the solid member and central hollow member and can withstand temperatures as high as 500 degrees Celsius and increase the production rate by 3 times thus reducing the operating cost.

I/We claim:

1. A heat transfer equipment, comprises of:
A central hollow member (101);
A solid member (201);
wherein the central hollow member (101) is cylindrical, triangular, square, pentagonal, hexagonal, heptagonal, octagonal;
wherein the solid member (201) is cylindrical, triangular, square, pentagonal, hexagonal, heptagonal, octagonal;
wherein the members for the central hollow (101) and solid member (201) are from metals, substances having malleable properties;
wherein the diameter of the solid member (201) is less than the diameter of the central member (101);

2. A method of producing the heat transfer equipment as claimed in claim 1 comprises:
preparing the solid member (201) into loops of predetermined height;
preparing the solid member (201) into members having crests and troughs wherein the distance between two consecutive crests is predetermined;

3. A method of preparing the heat transfer equipment as claimed in claim 1,
wherein the solid member (201) is welded and fused onto the surface of the central hollow member (101) by projecting the laser beam (301) on central hollow member (101) at the points of contacts of the troughs;

4. A method of preparing the heat transfer equipment as claimed in claim 1,
wherein the solid member (201) is welded onto the surface of the central hollow member (101) by projecting the laser beam (301) on the troughs before the troughs are brought in contact with the surface of central hollow member (101).

5. A method of preparing the heat transfer equipment as claimed in claim 1,
wherein the laser welding is done across the circumference of the central hollow member (101) in continuous manner and the solid member (201) is placed on it;

6. A method of preparing the heat transfer equipment as claimed in claims 3, 4 and 5
wherein the central hollow member (101) is rotated for complete laser welding of solid member (201) onto the surface of the central hollow member (101).
